(19) United States
(12) Patent Application Publication
(10) Pub. No.: US 2011/0161688 A1
(43) Pub. Date: Jun. 30, 2011

(54) INFORMATION PROCESSING APPARATUS

(75) Inventors: Junichi Nonomura, Tokyo (JP); Kazuhito Onuma, Fuchu-shi (JP)

(73) Assignee: KABUSHIKI KAISHA TOSHIBA, Tokyo (JP)

(21) Appl. No.: 12/949,732

(22) Filed: Nov. 18, 2010

(30) Foreign Application Priority Data
Dec. 25, 2009 (JP) 2009-294251

(51) Int. Cl. G06F 1/26

(52) U.S. Cl. 713/300

(57) ABSTRACT

According to one embodiment, an information processing apparatus includes a body housing comprising a top surface, a display housing connected to the body housing to pivotably move between a close position where the top surface is covered by the display housing and an open position where the top surface is opened, an acceleration sensor configured to detect an acceleration of the information processing apparatus, an opening/closing sensor configured to detect whether the display housing is located in the close position, an interface port provided in the body housing and configured to be connectable with an external device, and a controller configured to determine whether to power the interface port based on outputs of the acceleration sensor and the opening/closing sensor.

### CROSS REFERENCE TO RELATED APPLICATION(S)

The present disclosure relates to the subject matters contained in Japanese Patent Application No. 2009-294251 filed on Dec. 25, 2009, which are incorporated herein by reference in its entirety.

### FIELD

Embodiments, described herein relate generally to power saving control when an information processing apparatus is being carried.

### BACKGROUND

An information processing apparatus such as a personal computer is often designed on an assumption that a user will carry the apparatus. Generally, a notebook type personal computer can be driven either by electric power fed from an outside through an AC adapter connected to the personal computer or by electric power fed from a built-in battery included in the personal computer.

When the user carries the notebook type personal computer and uses it, the user often does not carry the AC adapter so that the personal computer is driven by electric power fed from the built-in battery. Therefore, a power saving technique for extending a battery drive time is important for the notebook type personal computer.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a perspective view showing an external appearance of a computer according to an embodiment.

FIG. 2 is a perspective view showing a back face of the computer according to the embodiment.

FIG. 3 is a block diagram showing a configuration of the computer according to the embodiment.

FIG. 4 is a view schematically showing a device setting table according to the embodiment.

FIG. 5 is a view schematically showing a pop-up message according to the embodiment.

FIG. 6 is a flow chart showing an example of procedure of power saving control according to the embodiment.

### DETAILED DESCRIPTION

In general, according to one embodiment, an information processing apparatus includes a body housing comprising a top surface, a display housing connected to the body housing to pivotably move between a close position where the top surface is covered by the display housing and an open position where the top surface is opened, an acceleration sensor configured to detect an acceleration of the information processing apparatus, an opening/closing sensor configured to detect whether the display housing is located in the close position, an interface port provided in the body housing and configured to be connectable with an external device, and a controller configured to determine whether to power the interface port based on outputs of the acceleration sensor and the opening/closing sensor.

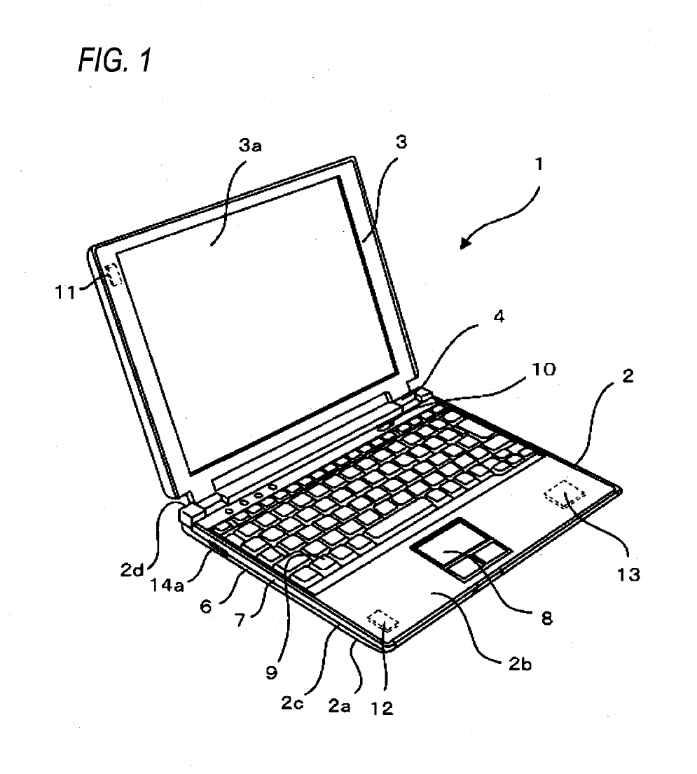

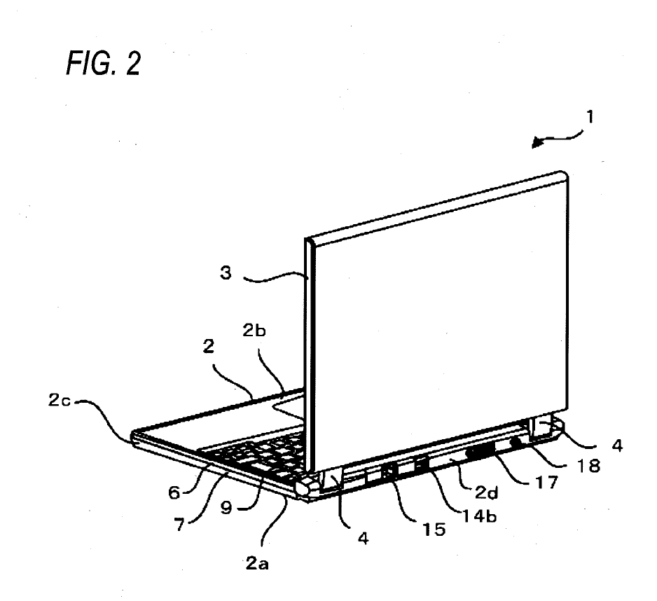

The embodiment will be described below with reference to the drawings. The embodiment will be described in the case where a notebook type computer is used as an electronic apparatus by way of example. FIGS. 1 and 2 are perspective views showing an external appearance of the computer according to the embodiment.

The computer 1 has a body housing 2, and a display housing 3. The body housing 2 is shaped like a flat box which has a bottom wall 2a, a top wall 2b, left and right side walls 2c, and a rear wall 2d. The top wall 2b supports a keyboard 9.

The body housing 2 is separated into a base 6 and a top cover 7. The base 6 is provided with the bottom wall 2a. The top cover 7 is provided with the top wall 2b. While the base 6 is covered with the top cover 7 from above, the top cover 7 is supported on the base 6 so as to be removable.

The display housing 3 is attached to the body housing 2 through hinge portions 4 so that the display housing 3 can rotate relative to the body housing 2. The display housing 3 can rotate between an open position where the top wall 2b of the body housing 2 is opened and a close position where the top wall 2b is covered with the display housing 3. A display device composed of a Liquid Crystal Display (LCD) 3a is embedded in the display housing 3.

A USB port 14a for connecting a USB device is provided in one of the left and right side walls 2c of the body housing 2. An LAN connector 15, a USB port 14b, an RGB connector 17, a DC-IN connector 18 for connecting an AC adapter, etc. are provided in the rear wall 2d of the body housing 2 so as to be exposed from the rear wall 2d. In the following description, the USB ports 14a and 14b will be referred to as USB ports 14 as long as it is unnecessary to distinguish the USB ports 14a and 14b from each other.

A touchscreen 8 and the keyboard 9 for allowing a user to perform an input operation are attached to the top wall 2b of the body housing 2. A power switch 10 for powering on/off the computer 1 is also provided in the top wall 2b.

Although FIGS. 1 and 2 show the case where the USB port 14a is provided in the side wall 2c and the USB port 14b is provided in the rear wall 2d by way of example, an arbitrary number of USB ports 14 can be provided in arbitrary places not exclusive to the side wall 2c and the rear wall 2d.

An opening/closing sensor 12 is provided in the body housing 2. The opening/closing sensor 12 is a sensor for detecting whether the display housing 3 is located in one of the open position where the top wall 2b is opened and in the close position where the top wall 2b is covered with the display housing 3.

For example, a Hall element is used as the opening/closing sensor 12. The Hall element is a magnetic sensor which uses a Hall effect. On the other hand, a magnet 11 is provided in the display housing 3.

When the magnet 11 in the display housing 3 comes near to the opening/closing sensor 12 in the body housing 2 because the display housing 3 is closed, the close state of the display housing 3 is detected. When the magnet 11 goes away from the opening/closing sensor 12 contrariwise, the open state of the display housing 3 is detected. In this manner, whether the display housing 3 is located in one of the open position and in the close position can be detected.

As another method, the opening/closing of the display housing 3 may be detected by use of a mechanism by which the opening/closing of the display housing 3 is interlocked with on/off of a mechanical switch.

Further, an acceleration sensor 13 is also provided in the body housing 2. The acceleration sensor 13 is a sensor for measuring acceleration imposed on an object. The acceleration sensor 13 can detect change in acceleration imposed on the computer 1 to thereby detect carrying of the computer 1.

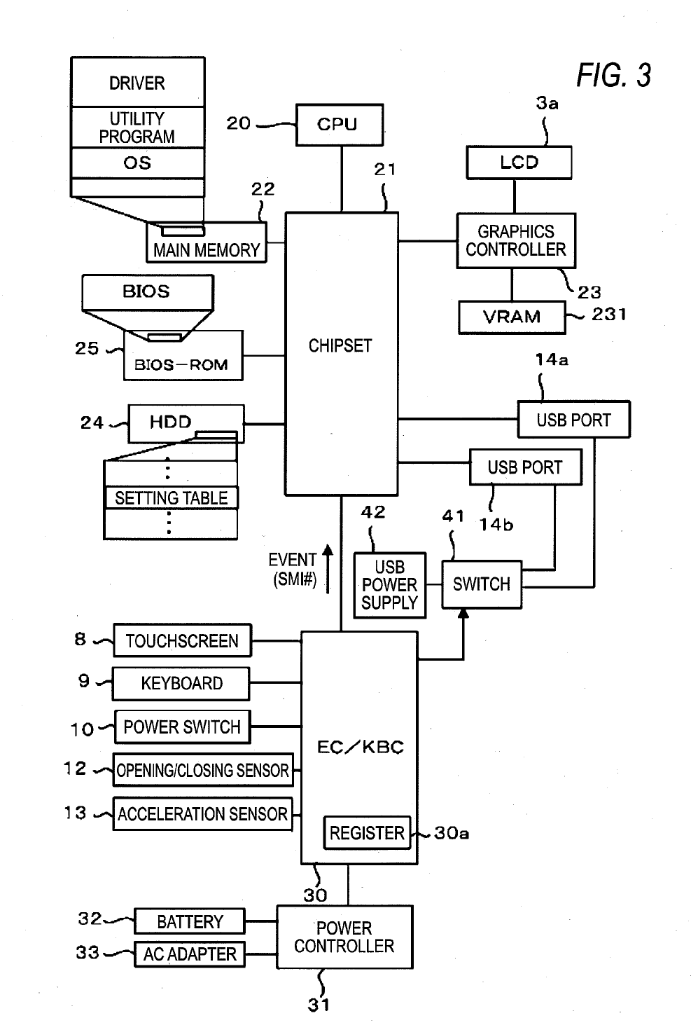

FIG. 3 is a block diagram showing a configuration of the computer 1 according to the embodiment. A CPU 20, a chipset 21, a main memory (RAM) 22, a graphics controller 23, a hard disk drive (HDD) 24, a BIOS-ROM 25, an embedded controller/keyboard controller IC (EC/KBC) 30, the display device 3a, the touchscreen 8, the keyboard 9, the power switch 10, etc. are provided in the computer 1.

The CPU 20 is a processor for controlling operations of respective components of the computer 1. The CPU 20 executes an operating system and various application programs/utility programs loaded from the HDD 24 to the main memory (RAM) 22. The main memory (RAM) 22 is also used as storage of various data buffers.

The CPU 20 also executes a Basic Input Output System (BIOS) stored in the BIOS-ROM 25. The BIOS is a program for controlling hardware. The BIOS includes a set of BIOS drivers. Each BIOS driver includes a set of function execution routines corresponding to hardware control functions in order to provide these functions to the operating system and the application programs.

The BIOS further executes processing for expanding the operating system from a storage device such as the HDD 24 to the main memory (RAM) 22 to enable the computer 1 to be operated by the user.

The chipset 21 has an interface with the CPU 20, an interface with the main memory (RAM) 22, and an interface with the graphics controller 23. Moreover, the chipset 21 performs control of USB devices connected to the USB ports 14a and 14b and communication with the EC/KBC 30.

The graphics controller 23 controls the LCD 3a used as a display monitor of the computer 1. The graphics controller 23 sends out a video signal corresponding to display data written into a VRAM 231 by the OS or an application program, to the LCD 3a.

The HDD 24 stores the OS, the various application programs/utility programs and data files.

The EC/KBC 30 is a one-chip microcomputer into which a controller for power management of the computer 1 and a keyboard controller for controlling the touchscreen 8 and the keyboard 9 are integrated.

The EC/KBC 30 cooperates with a power controller 31 to execute processing of powering on/off the computer 1 in response to a user's operation on the power switch 10. The power controller 31 feeds electric power to respective components of the computer 1 by using electric power fed from a built-in battery 32 included in the computer 1 or electric power fed from the outside through an AC adapter 33.

A register 30a is provided in the EC/KBC 30. A result of the close state of the display housing 3 detected by the opening/closing sensor 12 and a result that the acceleration sensor 13 detects a change in acceleration imposed on the computer 1 are stored in the register 30a.

A switch 41 is used for controlling power supply to the USB ports 14a and 14b. When the switch 41 is turned on, electric power is fed from a USB power supply 42 to the USB ports 14a and 14b. When the switch 41 is turned off, electric power is not fed from the USB power supply 42 to the USB ports 14a and 14b.

Moreover, the switch 41 can be controlled to take a state where the USB port 14b is not supplied with any electric power but the USB 14a is supplied with electric power, or a state where the USB port 14b is supplied with electric power but the USB port 14a is not supplied with any electric power. Therefore, states of electric power supply to the USB ports 14a and 14b can be controlled individually. Such control can be achieved in such a manner that the state of the switch 41 is turned in accordance with an instruction given from the EC/KBC 30.

In the embodiment, the USB ports 14a and 14b are controlled to be enabled or disabled in accordance with the detection result of the opening/closing sensor 12, the detection result of the acceleration sensor 13, the types of devices connected to the USB ports 14a and 14b, etc.

In brief, “a USB port 14 is enabled” means a state where the USB port 14 is supplied with electric power. That is, a device connected to the USB port 14 can be supplied with electric power, so that the computer 1 can communicate with the connected device through the chipset 21.

On the other hand, “a USB port 14 is disabled” means a state where the USB port 14 is not supplied with any electric power. When the USB port 14 is disabled, a device connected to the USB port 14 cannot be supplied with any electric power, so that the computer 1 cannot communicate with the connected device through the chipset 21.

A process for setting the USB ports to be enabled or disabled will be described below with reference to FIG. 3.

First, when a specific event occurs, the EC/KBC 30 sends a System Management Interrupt (SMI) signal to the chipset 21. For example, the specific event is an event that a specific key from the keyboard 9 is inputted. An event that the opening/closing sensor 12 detects the close state of the display housing 3 is also an example of the specific event. An event that the acceleration sensor 13 detects change in acceleration imposed on the computer 1 to thereby detect carrying of the computer 1 is another example of the specific event. The EC/KBC 30 is notified of inputting of a specific key from the keyboard 9, a detection result of the opening/closing sensor 12 and a detection result of the acceleration sensor 13. Upon reception of these notifications, the EC/KBC 30 sends an SMI signal to the chipset 21.

When the chipset 21 receives the SMI signal, the CPU 20 executes a driver program to check whether there is any device connected to either of the USB ports 14a and 14b or not. When there is no device connected to the USB ports 14a and 14b, a command to disable the USB ports 14a and 14b is sent to the EC/KBC 30 through the driver program executed by the CPU 20. Upon reception of the command, the EC/KBC 30 turns the state of the switch 41 so that the USB ports 14a and 14b are not supplied with any electric power from the USB power supply 42.

When a command to disable only one USB port 14a of the USB ports 14a and 14b is sent to the EC/KBC 30, the EC/KBC 30 turns the state of the switch 41 so that the USB port 14a is not supplied with any electric power from the USB power supply 42.

A method of interposing the chipset 21 and the driver program executed by the CPU 20 has been described above as a process for setting the USB ports 14 to be enabled or disabled.

As a simpler method, the EC/KBC 30 having received a specific event through the keyboard 9, the opening/closing sensor 12 or the acceleration sensor 13 may control the switch 41 to be turned on and off directly.

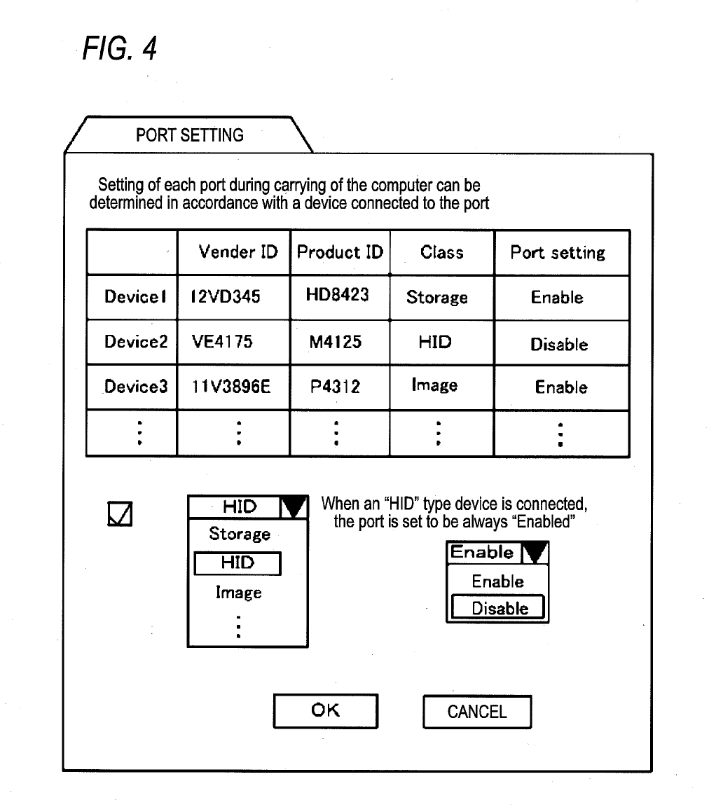

FIG. 4 is a view schematically showing a device setting table (user interface) according to the embodiment.

In the embodiment, the setting table (user interface) shown in FIG. 4 can be provided to the user through a utility program.

Each USB port 14 to which a USB device is connected can be set to be enabled or disabled through the utility program. That is, when the USB ports 14 are set to be enabled on the “Port Setting” table, the USB ports 14 are supplied with electric power even during carrying of the computer 1. On the other hand, when the USB ports 14 are set to be disabled on the “Port Setting” table, the USB ports 14 are not supplied with any electric power during carrying of the computer 1.

Whether the USB ports 14 are enabled or disabled during carrying of the computer 1 can be set individually in accordance with a USB device connected to each of the USB ports 14. That is, even the USB port 14a may be set so that the USB port 14a is enabled when a first USB device is connected to the USB port 14a, but the USB port 14a is disabled when a second USB device is connected to the USB port 14a. In a similar way, even the USB port 14b may be set so that the USB port 14b is enabled when the first USB device is connected to the USB port 14b, but the USB port 14b is disabled when the second USB device is connected to the USB port 14b.

On the other hand, setting may be made generically in accordance with the device type of each USB device. That is, the USB port 14 may be set so that the USB port 14 is enabled when the type of the device connected to the USB port 14 is a storage device such as a memory or an HDD, but the USB port 14 is disabled when the type of the device connected to the USB port 14 is an input device such as a mouse or a keyboard.

When a USB device is connected to the computer 1, the computer 1 communicates with the USB device. The computer 1 receives information such as the vender ID, product ID, device class, etc. of the USB device from the USB device.

The vender ID is identification information for identifying a name of a manufacturer manufacturing the USB device. The product ID is identification information for identifying a product model number of the USB device. The device class is identification information for identifying a type of the USB device. A device class “Storage” indicates that the USB device is a storage device such as a memory or an HDD. A device class “HID” indicates that the USB device is a human interface device. Representative examples of the human interface device are input devices such as a mouse and a keyboard. A device class “Image” indicates that the USB device is an imaging device such as a printer.

The utility program is executed so that a setting whether the USB port 14 is set to be enabled or disabled when a USB device is connected to the USB port 14 is associated with the vender ID, the product ID and the device class of the USB device. The setting is stored as a setting table in the HDD 24.

Incidentally, there may be the case where a file in a USB memory connected to the USB port 14 is opened during carrying of the computer 1. Accordingly, the USB port 14 to which the USB memory is connected may be set to be enabled. On the other hand, enabling/disabling the USB port 14 may be switched over in accordance with the presence/absence of file access to the USB memory connected to the USB port 14.

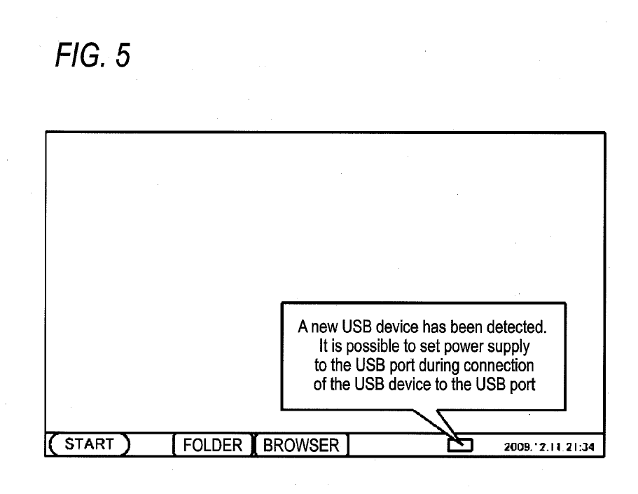

FIG. 5 is a view schematically showing a pop-up message according to the embodiment. When connection of a USB device to the computer 1 is detected, a pop-up message shown in FIG. 5 is displayed on the LCD 3a. When the user moves a cursor through the touchscreen 8 or the like and clicks the pop-up message, the setting table (user interface) shown in FIG. 4 may be also displayed on the LCD 3a. It is a matter of course that setting may be made so that the pop-up message is not displayed when a USB device is connected to the computer 1.

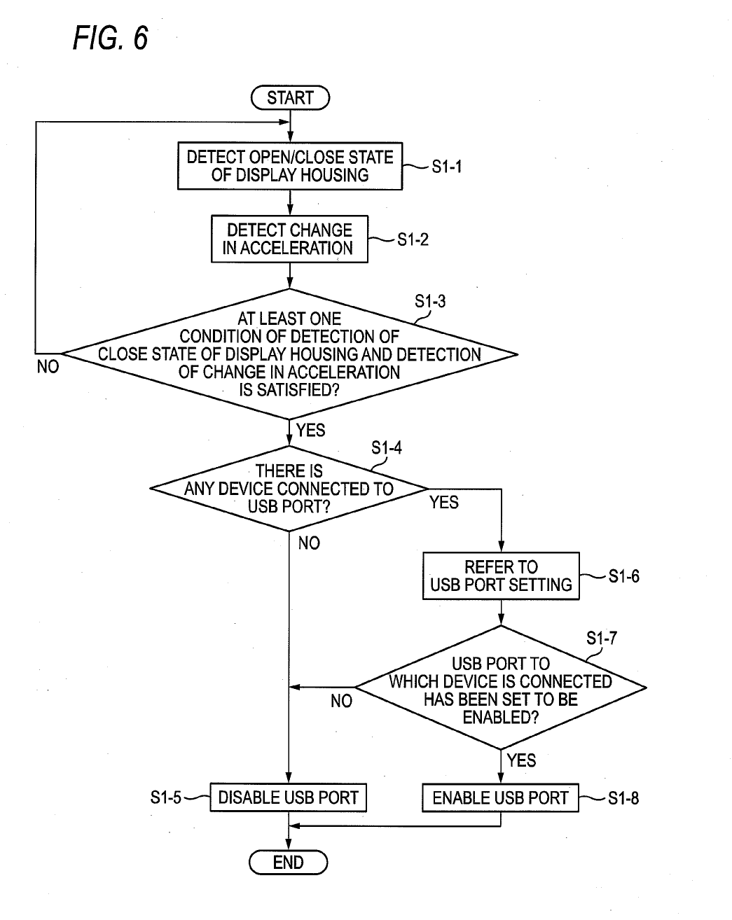

FIG. 6 is a flow chart showing an example of procedure of power saving control according to the embodiment.

Whether the display housing 3 is located in the open position relative to the body housing 2 or the display housing 3 is located in the close position relative to the body housing 2 is detected by the opening/closing sensor 12 (S1-1). The acceleration sensor 13 detects the change in acceleration imposed on the computer 1 so that whether the computer 1 is being carried or not is detected (S1-2). Although description of the flow chart shown in FIG. 6 shows the case where detection is made by the opening/closing sensor 12, and then detection is made by the acceleration sensor 13, the description is for the sake of convenience. There is no limitation on the sequence of detection by the opening/closing sensor 12 and detection by the acceleration sensor 13. For example, detection by the opening/closing sensor 12 and detection by the acceleration sensor 13 may be made simultaneously.

When at least one condition of detection of the close position of the display housing 3 by the opening/closing sensor 12 and detection of change in acceleration imposed on the computer 1 by the acceleration sensor 13 is satisfied (Yes in S1-3), it is successively determined whether there is any device connected to the USB port 14 or not (S1-4). The fact that the above-mentioned at least one condition is satisfied means the fact that there is a possibility that the computer 1 will be carried after the detection of the close position or change in acceleration. Even when the display housing 3 is open, there may be the case where the computer 1 is carried in a state where the display housing 3 is not closed but opened. It may be determined that the computer 1 will be carried when both conditions of detection of the close position of the display housing 3 by the opening/closing sensor 12 and detection of change in acceleration imposed on the computer 1 by the acceleration sensor 13 are satisfied.

When neither the close position of the display housing 3 nor change in acceleration imposed on the computer 1 is detected (No in S1-3), the open/close state of the display housing 3 and change in acceleration imposed on the computer 1 are monitored continuously.

When either condition of detection of the close position of the display housing 3 and detection of change in acceleration imposed on the computer 1 is satisfied, it is successively determined whether there is any USB device connected to the USB port 14 or not (S1-4). When there is no USB device connected to the USB port 14 (No in S1-4), a command to disable the USB port 14 is sent to the EC/KBC 30 so that the USB port 14 is disabled (S1-5). Because the USB port 14 is disabled when there is no USB device connected to the USB port 14, unnecessary electric power can be prevented from being consumed through the USB port 14 during carrying of the computer 1.

On the other hand, when there is some USB device connected to the USB port 14 (Yes in S1-4), the CPU 20 refers to setting of the USB 14 (S1-6). When the USB port 14 is set to be disabled as a result of the CPU 20's referring to the setting table as shown in FIG. 4 (No in S1-7), a command to disable the USB port 14 is sent to the EC/KBC 30 so that the USB port 14 is disabled (S1-5).

On the other hand, when the USB port 14 is set to be enabled (Yes in S1-7), a command to enable the USB port 14 is sent to the EC/KBC 30 so that the USB port 14 is enabled (S1-8).

When the USB ports of the personal computer are controlled to be not supplied with electric power during movement of the personal computer as described in the embodiment, input by mistake from the USB mouse and the USB keyboard can be prevented and power consumption through the USB ports can be reduced.

Although the embodiment is described on USB ports by way of example, it is not limited to the USB ports. For example, control described in the embodiment can be applied to any ports (interfaces) other than the USB ports. That is, when the interfaces are set to be enabled/disabled in the same manner as described above, power consumption through the interfaces can be reduced and input by mistake from input devices connected to the interfaces can be prevented as long as the interfaces can be supplied with electric power so that signals can be transmitted/received.

According to the embodiment, it is possible to provide an information processing apparatus in which power saving control can be made during carrying of the information processing apparatus, and in which input by mistake from an input device connected to the information processing apparatus can be prevented.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a body housing comprising a top surface;
a display housing connected to the body housing and configured to pivotably move between a closed position where the top surface is covered by the display housing and an open position where the top surface is opened;
an acceleration sensor configured to detect an acceleration of the information processing apparatus;
an opening and closing sensor configured to detect whether the display housing is located in the closed position;
an interface port provided in the body housing and configured to be connectable with an external device; and
a controller configured to determine whether to power the interface port based on outputs of the acceleration sensor and the opening and closing sensor.

2. The apparatus of claim 1, wherein the controller is configured to determine whether to power the interface port based on a type of the external device.

3. The apparatus of claim 2 further comprising:
a storage device configured to store identification information of the external device.

4. The apparatus of claim 3, wherein the controller is configured to cut off electric power supply to the interface port if the external device comprises a user interface.

5. The apparatus of claim 3, wherein the controller is configured to continue powering the interface port if the external device comprises a storage device.

6. An information processing apparatus comprising:
a body housing comprising a top surface;
a display housing connected to the body housing configured to pivotably move between a closed position where the top surface is covered by the display housing and an open position where the top surface is opened;
an acceleration sensor configured to detect an acceleration of the information processing apparatus;
an opening and closing sensor configured to detect whether the display housing is located in the closed position;
an interface port provided in the body housing and configured to be connectable with an external device; and
a controller configured to determine whether to power the interface port based on at least one of outputs of the acceleration sensor and the opening and closing sensor.
